(19) United States
(12) Patent Application Publication
(10) Pub. No.: US 2026/0088932 A1
(43) Pub. Date: Mar. 26, 2026

(54) DATA PROCESSING METHOD AND RELATED PRODUCTS

(71) Applicant: Huawei Technologies Co., Ltd., Shenzhen (CN)

(72) Inventors: Huazi Zhang, Hangzhou (CN); Hao Tang, Ottawa (CA); Xiaoyan Bi, Shanghai (CN); Jianglei Ma, Ottawa (CA); Wen Tong, Ottawa (CA)

(21) Appl. No.: 19/402,633

(22) Filed: Nov. 26, 2025

Related U.S. Application Data
(63) Continuation of application No. PCT/CN2023/114301, filed on Aug. 22, 2023.
(60) Provisional application No. 63/505,553, filed on Jun. 1, 2023.

(51) Int. Cl. H04L 1/00; H04L 1/1607; H04L 27/26; H04L 47/80

(52) U.S. Cl. CPC H04L 1/0057; H04L 1/0041; H04L 1/1671; H04L 27/26; H04L 47/805

(57) ABSTRACT

A data processing method and related products are provided in embodiments of the present disclosure. The data processing method includes: obtaining, by a terminal device, M sequences based on at least two payloads, where at least one of the M sequences includes a first payload and a second payload of the at least two payloads, the first payload and the second payload have different priorities; where M is an integer greater than 1; processing, by the terminal device, the M sequences to obtain corresponding codewords. A sequence is obtained through combining payloads with different priorities, and then the sequence is processed to obtain a codeword, in this manner, joint encoding of payloads with different priorities is implemented, thus, payloads with different priority levels can be differentially transmitted.

### CROSS-REFERENCE TO RELATED APPLICATIONS

This application is a continuation of International Application No. PCT/CN2023/114301, filed on Aug. 22, 2023, which claims priority to U.S. Patent Application No. 63/505,553, entitled “HARQ PROCEDURE FOR MIXED TRAFFIC” and filed on Jun. 1, 2023. The disclosures of each of the above patent applications are incorporated herein by reference in their entirety.

### TECHNICAL FIELD

The present disclosure relates to the field of communication technologies, and in particular, to a data processing method and related products.

### BACKGROUND

A physical uplink control channel (PUCCH) is mainly used to carry uplink control information (UCI). Specifically, UCI may include information about applying for an uplink resource configuration by a terminal device from a network device, information about replying whether downlink service data is correctly received by the terminal device, or channel state information (CSI) of a downlink channel reported by the terminal device. A physical uplink shared channel (PUSCH) is used to transmit uplink service data. The PUSCH may be dynamically scheduled by using DCI, or may be configured by using a higher layer parameter for scheduling-free transmission, or may be semi-persistent scheduling by using DCI after the higher layer parameter is configured.

Joint coding may be used for mixed traffic, where the mixed traffic corresponds to different UCI contents, or sensing-related data, or any payload data that is transmitted on a PUCCH or a PUSCH.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a data processing method, including:
obtaining, by a terminal device, M sequences based on at least two payloads, where at least one of the M sequences includes a first payload and a second payload of the at least two payloads, the first payload and the second payload have different priorities; where M is an integer greater than 1;
processing, by the terminal device, the M sequences to obtain corresponding codewords.

A sequence is obtained through combining payloads with different priorities, and then the sequence is processed to obtain a codeword, in this manner, joint encoding of payloads with different priorities is implemented, thus, payloads with different priority levels can be differentially transmitted, thereby providing unequal error protection from the perspective of channel coding.

In a possible implementation of the first aspect, the first payload is shared by at least two of the M sequences.

By making the first payload be shared by at least two sequences, the first payload can be encoded multiple times into different codewords, the first payload can thus be provided with additional reliability.

In a possible implementation of the first aspect, the method further includes: receiving, by the terminal device, a first notification from a network device, where the first notification is indicative of whether joint coding is enabled for the M sequences;
where the obtaining, by a terminal device, M sequences based on at least two payloads includes:
upon determining that the first notification is indicative of joint coding being enabled for the M sequences, obtaining, by the terminal device, the M sequences based on the at least two payloads.

Joint encoding of payloads with different priorities is implemented through the notification from the network device, by considering the compatibility with legacy coding schemes, the proposed joint encoding provides more flexibility and can thus meet different requirements.

In a possible implementation of the first aspect, the obtaining, by the terminal device, M sequences based on at least two payloads includes:
determining, by the terminal device, respective priorities for the at least two payloads;
obtaining, by the terminal device, the M sequences according to a predefined mapping order and the respective priorities.

In a possible implementation of the first aspect, the determining, by the terminal device, respective priorities for the at least two payloads includes:
determining, by the terminal device, the respective priorities for the at least two payloads according to a predefined priority determination criterion; or,
receiving, by the terminal device, a second notification from a network device, and determining the respective priorities for the at least two payloads according to the second notification, where the second notification is indicative of priorities of different payloads included in the at least two payloads.

In a possible implementation of the first aspect, the priority determination criterion is to determine a priority of a payload according to a relationship between a length of the payload and a predefined length threshold, or to determine a priority of a payload according to a type of the payload.

In a possible implementation of the first aspect, the terminal device is configured with a first correspondence between priorities and codeword sets;
the obtaining, by the terminal device, the M sequences according to a predefined mapping order and the respective priorities includes:
determining, by the terminal device, at least one sequence index corresponding to each of the at least two payloads according to the first correspondence and the respective priorities for the at least two payloads;
obtaining, by the terminal device, the M sequences according to the at least one sequence index corresponding to each of the at least two payloads.

Joint encoding of payloads with different priorities is implemented through the correspondence between a priority and a codeword set, the joint encoding can be implemented in an implicit way with higher security.

In a possible implementation of the first aspect, the terminal device is configured with a set of pre-configurations for obtaining the M sequences;
the method further includes:
receiving, by the terminal device, a third notification from a network device, where the third notification is indicative of a manner for obtaining the M sequences;
selecting, by the terminal device according to the third notification, a mapping configuration from the set of pre-configurations as the predefined mapping order.

Joint encoding of payloads with different priorities is implemented through pre-configurations, thus a more flexible manner to configure the mixed-priority encoding is provided, and data channel in the framework can easily be included in the mixed-priority encoding. In other words, a generally applicable design of mixed-priority encoding is provided, and a joint encoding scheme can be configured more flexibly according to actual requirements.

In a possible implementation of the first aspect, the terminal device is configured with a second correspondence between a payload and a codeword set for carrying the payload;
the obtaining, by the terminal device, the M sequences based on the at least two payloads includes:
determining, by the terminal device, at least one sequence index corresponding to each of the at least two payloads according to the second correspondence and types of the at least two payloads;
obtaining, by the terminal device, the M sequences according to the at least one sequence index corresponding to each of the at least two payloads.

Joint encoding of payloads with different priorities is implemented through the correspondence between a payload and a codeword set for carrying the payload, without having to explicitly define or determine the priority indexes of multiple payloads, the overhead is small.

In a possible implementation of the first aspect, the method further includes:
determining, by the terminal device, whether there exists, among the at least two payloads, a reusable payload having a zero part;
upon determining that there exists the reusable payload having the zero part, filling, by the terminal device, at least a part of a payload satisfying a predefined filling criterion to the zero part of the reusable payload, and using the filled reusable payload for the obtaining of the M sequences.

Since the zero part is filled with bits of a certain payload, the zero part can be utilized to transmit the filled payload bits, the utilization rate of the payload is thus improved, meanwhile, the bits filled in the zero part of the reusable payload can also benefit from joint encoding.

In a possible implementation of the first aspect, the processing, by the terminal device, the M sequences to obtain corresponding codewords includes:
performing, by the terminal device, interleaving processing on a first sequence of the M sequences;
encoding, by the terminal device, the first interleaved sequence and a rest of the M sequences according to a coding scheme corresponding to each of the M sequences to obtain the corresponding codewords;
the method further includes:
performing, by the terminal device, rate matching on the corresponding codewords.

In a possible implementation of the first aspect, a length of an output sequence of the rate matching for a codeword is determined based on a manner in which a sequence corresponding to the codeword is obtained.

The above solution brings minimum impact to the existing structure. In addition, the unequal error protection for payloads with different priorities is provided.

In a possible implementation of the first aspect, the first payload is determined based on a relationship between a number of bits of a to-be-shared payload from which the first payload comes and a predefined sharing threshold; or, the first payload is determined based on a predefined number of codewords for carrying the to-be-shared payload and a number of bits of the to-be-shared payload.

In a possible implementation of the first aspect, the first payload has a highest priority among the at least two payloads.

In a possible implementation of the first aspect, the method further includes: sending, by the terminal device, the codewords corresponding to the M sequences to a network device.

In a second aspect, an embodiment of the present disclosure provides a data processing method, including:
receiving, by a network device, codewords from a terminal device, where the codewords are obtained by the terminal device through processing M sequences, the M sequences are obtained based on at least two payloads, where at least one of the M sequences includes a first payload and a second payload of the at least two payloads, the first payload and the second payload have different priorities; where M is an integer greater than 1.

In a possible implementation of the second aspect, the method further includes: sending, by the network device, a first notification to the terminal device, where the first notification is indicative of whether joint coding is enabled for the M sequences, so that the terminal device obtains the M sequences based on the at least two payloads upon determining that the first notification is indicative of joint coding being enabled for the M sequences.

In a possible implementation of the second aspect, the method further includes: sending, by the network device, a second notification to the terminal device, where the second notification is indicative of priorities of different payloads included in the at least two payloads, so that the terminal device determines respective priorities for the at least two payloads according to the second notification and obtains the M sequences according to a predefined mapping order and the respective priorities.

In a possible implementation of the second aspect, the method further includes: sending, by the network device, a third notification to the terminal device, where the third notification is indicative of a manner for obtaining the M sequences, so that the terminal device selects, according to the third notification, a mapping configuration from a set of pre-configurations configured for the terminal device as a predefined mapping order and obtains the M sequences according to a predefined mapping order and respective priorities.

In a third aspect, an embodiment of the present disclosure provides a data processing apparatus, the apparatus includes various modules configured to execute the data processing method according to the first aspect or any possible implementation of the first aspect.

In a fourth aspect, an embodiment of the present disclosure provides a data processing apparatus, the apparatus includes various modules configured to execute the data processing method according to the second aspect or any possible implementation of the second aspect.

In a fifth aspect, an embodiment of the present disclosure provides a terminal device including processing circuitry for executing the data processing method according to the first aspect or any possible implementation of the first aspect.

In a sixth aspect, an embodiment of the present disclosure provides a network device including processing circuitry for executing the data processing method according to the second aspect or any possible implementation of the second aspect.

In a seventh aspect, an embodiment of the present disclosure provides a wireless communication system including a terminal device according to the fifth aspect and a network device according to the sixth aspect.

In an eighth aspect, an embodiment of the present disclosure provides a chip, including an input/output (I/O) interface and a processor, where the processor is configured to call and run computer execution instructions stored in a memory, to enable a device installing with the chip to execute the data processing method according to the first or second aspect or any possible implementation of the first or second aspect.

In a ninth aspect, an embodiment of the present disclosure provides a computer-readable medium storing computer execution instructions which, when executed by a processor, causes the processor to execute the data processing method according to the first or second aspect or any possible implementation of the first or second aspect.

In a tenth aspect, an embodiment of the present disclosure provides a computer program product including computer execution instructions which, when executed by a processor, causes the processor to execute the data processing method according to the first or second aspect or any possible implementation of the first or second aspect.

The present disclosure provides a data processing method and related products. A sequence is obtained through combining payloads with different priorities, and then the sequence is processed to obtain a codeword, in this manner, joint encoding of payloads with different priorities is implemented, thus, payloads with different priority levels can be differentially transmitted, thereby providing unequal error protection from the perspective of channel coding.

### BRIEF DESCRIPTION OF THE DRAWINGS

The accompanying drawings are used to provide a further understanding of the present disclosure, constitute a part of the specification, and are used to explain the present disclosure together with the following specific embodiments, but should not be construed as limiting the present disclosure.

FIG. 1 is a schematic illustration of a communication system according to one or more embodiments of the present disclosure.

FIG. 2 is another schematic illustration of a communication system according to one or more embodiments of the present disclosure.

FIG. 3 is a schematic illustration of basic component structure of a communication system according to one or more embodiments of the present disclosure.

FIG. 4 illustrates a block diagram of a device in a communication system according to one or more embodiments of the present disclosure.

FIG. 5 is a schematic illustration of a 6G multi-service scenario according to one or more embodiments of the present disclosure.

FIG. 6a and FIG. 6b are schematic illustrations of self-decoding and joint-decoding according to one or more embodiments of the present disclosure.

FIG. 7 is a schematic illustration of joint coding of two packets according to one or more embodiments of the present disclosure.

FIG. 8 is another schematic illustration of joint coding of two packets according to one or more embodiments of the present disclosure.

FIG. 9 is a schematic illustration of a resource mapping design in related art.

FIG. 10 is a schematic illustration of a resource mapping design according to one or more embodiments of the present disclosure.

FIG. 11 is a schematic flowchart of a data processing method according to one or more embodiments of the present disclosure.

FIG. 12 is a schematic flowchart of another data processing method according to one or more embodiments of the present disclosure.

FIG. 13 is a schematic illustration of joint coding for UCI contents according to one or more embodiments of the present disclosure.

FIG. 14 is a schematic illustration of a first correspondence between priorities and codeword sets according to one or more embodiments of the present disclosure.

FIG. 15 is a schematic illustration of of a pre-configuration for joint encoding according to one or more embodiments of the present disclosure.

FIG. 16 is a schematic illustration of of another pre-configuration for joint encoding according to one or more embodiments of the present disclosure.

FIG. 17 is a schematic flowchart of yet another data processing method according to one or more embodiments of the present disclosure.

FIG. 18 is a schematic illustration of a second correspondence between a payload and a codeword set for carrying the payload according to one or more embodiments of the present disclosure.

FIG. 19 is a schematic flowchart of still another data processing method according to one or more embodiments of the present disclosure.

FIG. 20 is a schematic illustration of filling a zero part of a payload according to one or more embodiments of the present disclosure.

FIG. 21 is a block diagram of a data processing apparatus according to one or more embodiments of the present disclosure.

### DETAILED DESCRIPTION OF THE ILLUSTRATIVE EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

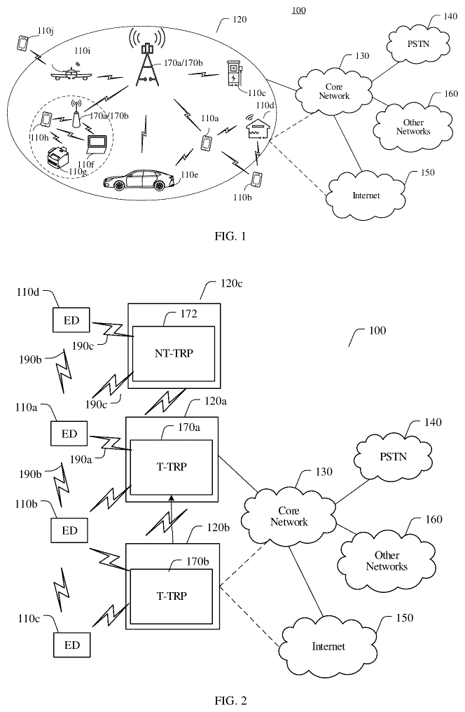

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

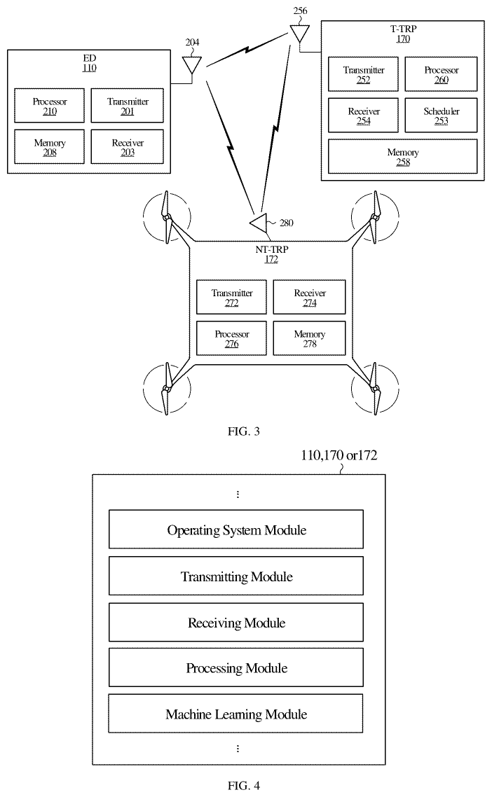

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

### Basic Module Structure

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### 6G Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:

(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.

(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.

(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cells, Carriers, Bandwidth Parts (BWPs) and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more BWPs. For example, a carrier may have one or more BWPs. More generally, wireless communication with the device may occur over a wireless spectrum. The spectrum may include one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, e.g. sidelink transmitting and receiving resources.

A BWP may be broadly defined as a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may include non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Terminal Types

The communication method provided in this embodiment of this disclosure may be applied to various communication scenarios, for example, may be applied to one or more of the following communication scenarios: enhanced mobile broadband (enhanced mobile broadband, eMBB), ultra-reliable low-latency communication (ultra reliable low latency communication, URLLC), and machine type communication (machine type communication). MTC), Internet of Things (IoT), narrowband Internet of Things (narrow band internet of thing, NB-IoT), customer front-end equipment (customer front-end equipment, CPE), augmented reality (augmented reality, AR), virtual reality (virtual reality, VR), mass machine type communications (mMTC), device to device (D2D), vehicle to everything (V2X), vehicle to vehicle (V2V), etc.

It should be noted that in this embodiment of this disclosure, IoT (internet of thing, IoT) may include one or more of NB-IoT, MTC, mMTC, and the like. This is not limited.

The eMBB may be a large-traffic mobile broadband service such as a three-dimensional (three-dimensional, 3D) or ultra-high-definition video. Specifically, the eMBB may further improve performance such as a network speed and user experience based on a mobile broadband service. For example, when a user watches a 4K HD video, the peak network speed can reach 10 Gbit/s.

URLLC may refer to a service with high reliability, low latency, and extremely high availability. Specifically, the URLLC may include the following communications scenarios and applications: industrial application and control, traffic safety and control, remote manufacturing, remote training, remote surgery, unmanned driving, industrial automation, a security industry, and the like.

MTC may refer to a low-cost and coverage-enhanced service, and may also be referred to as M2M. mMTC refers to large-scale IoT services.

NB-IoT may be a service that features wide coverage, a large number of connections, a low rate, a low cost, low power consumption, and an excellent architecture. Specifically, the NB-IoT may include a smart water meter, smart parking, intelligent pet tracking, a smart bicycle, an intelligent smoke detector, an intelligent toilet, an intelligent vending machine, and the like.

The CPE may refer to a mobile signal access device that receives a mobile signal and forwards the mobile signal by using a wireless fidelity (wireless fidelity, WiFi) signal, or may refer to a device that converts a high-speed 4G or 5G signal into a WiFi signal, and may simultaneously support a relatively large quantity of mobile terminals that access the Internet. CPEs can be widely used for wireless network access in rural areas, towns, hospitals, units, factories, and residential areas, reducing the cost of laying wired networks.

The V2X can enable communication between vehicles, between vehicles and network devices, and between network devices, to obtain a series of traffic information such as a real-time road condition, road information, and pedestrian information, and provide in-vehicle entertainment information to improve driving safety, reduce congestion, and improve traffic efficiency.

For example, the terminal type includes an eMBB device, a URLLC device, an NB-IoT device, and a CPE device. The eMBB device is mainly configured to transmit large-packet data, or may be configured to transmit small-packet data, and is generally in a moving state. Requirements for a transmission delay and reliability are general, and both uplink and downlink communication exists. A channel environment is relatively complex and changeable, and indoor communication or outdoor communication may be used. For example, an eMBB device may be a mobile phone. The URLLC device is mainly configured to transmit small packet data, or may transmit medium packet data. Generally, the URLLC device belongs to a non-moving state, or may move along a fixed route. The URLLC device has a relatively high requirement for a transmission delay and reliability, that is, a low transmission delay and high reliability are required, and both uplink and downlink communications have. The channel environment is stable. For example, the URLLC device may be a factory device. The NB-IoT device is mainly used to transmit small data. The NB-IoT device is generally in a non-moving state, has a known location, has a medium transmission delay and reliability requirement, has a relatively large amount of uplink communication, and has a relatively stable channel environment. For example, the NB-IoT device may be a smart water meter or a sensor. The CPE device is mainly used to transmit large-packet data, is generally in a non-mobile state, or can move over ultra-short distances, has medium requirements on transmission delay and reliability, has both uplink and downlink communication, and has a relatively stable channel environment. For example, The CPE device may be a terminal device, an AR, a VR, or the like in the smart home. When the terminal type of the terminal device is determined, the terminal type may be determined based on a service type, mobility, a transmission delay requirement, a reliability requirement, a channel environment, and a communication scenario of the terminal device. Determining that the terminal type corresponding to the terminal device is an eMBB device, a URLLC device, an NB-IoT device, or a CPE device.

It should be noted that the eMBB device may alternatively be described as eMBB, the URLLC device may alternatively be described as URLLC, the NB-IoT device may alternatively be described as NB-IoT, and the CPE device may alternatively be described as CPE. The V2X device may also be described as a V2X device, which is not limited.

### Physical Uplink Control Channel (PUCCH) and Physical Transmit Link Control Channel (PTxCCH)

A physical uplink control channel (physical uplink control channel, PUCCH) is mainly used to carry uplink control information (uplink control information, UCI). Specifically, the information may include information about applying for an uplink resource configuration by the terminal device from the network device, information about replying whether the downlink service data is correctly received by the terminal device, and channel state information (channel state information, CSI) of the downlink channel reported by the terminal device.

In a possible implementation, a physical layer control channel, that is, a physical transmission link control channel (physical transmission link control channel, PTxCCH), may be introduced. A function of the PTxCCH is similar to that of a PUCCH in LTE and 5G. Specifically, the channel is used by the terminal device to transmit control information, and/or is used by the network device to receive control information. The control information may include at least one of the following: ACK/NACK information, channel state information, a scheduling request, and the like. It should be understood that, generally, the standard protocol is described from a perspective of a terminal device. Therefore, the physical layer uplink control channel may be described as a physical layer transmit link control channel.

### Physical Uplink Shared Channel (PUSCH) and Physical Transmit Link Shared Channel (PTxSCH)

A physical uplink shared channel (physical uplink shared channel, PUSCH) is used to transmit uplink service data. The PUSCH may be dynamically scheduled by using DCI, or may be configured by using a higher layer parameter for scheduling-free transmission, or may be semi-persistent scheduling by using DCI after the higher layer parameter is configured.

A PUSCH sending procedure may include processes such as scrambling, modulation, layer mapping, conversion precoding, precoding, resource mapping, and symbol generation.

In a possible implementation, a physical layer data channel, that is, a physical transmission link shared channel (physical transmission link shared channel, PTxSCH), may be introduced. A function of the PTxSCH is similar to that of a PUSCH in LTE and 5G. Specifically, the channel is used by the terminal device to transmit data, and/or is used by the network device to receive data. It should be understood that, generally, the standard protocol is described from a perspective of a terminal device. Therefore, an uplink data channel at a physical layer may be described as a data sending channel at a physical layer.

### Downlink Control Information (DCI)

Downlink control information (DCI) is control information that is transmitted on a PDCCH and that is related to a PDSCH and a PUSCH. The terminal device can correctly process the PDSCH data or the PUSCH data only when the DCI information is correctly decoded.

Uses of different DCI may be different, for example, DCI used for uplink/downlink transmission resource allocation, DCI used for uplink power control adjustment, and DCI used for downlink dual-stream spatial multiplexing. Different DCI formats may be used for differentiation of DCI for different purposes.

Specifically, the information included in the DCI may be classified into three types, and the DCI may include at least one of the three types. The first-type information is information used for channel estimation, for example, a time-frequency resource indication or a demodulation reference signal (demodulation reference signal, DMRS). The second type of information is information used to decode the PDSCH, for example, a modulation and coding scheme (modulation and coding scheme, MCS), a hybrid automatic repeat request process number (hybrid automatic repeat request process number, HARQ process number), and a new data indicator (new data indicator, NDI). The third type of information is information used to send UCI, for example, a PUCCH resource, transmit power control (Transmit power control, TPC), code block group transmission information (Code block group transmission information, CBG) configuration, and channel state information (Channel state information). CSI) trigger information, sounding reference signal (Sounding reference signal, SRS) trigger information, and the like.

To reduce a quantity of blind detection times of the terminal device, it is proposed that information included in the DCI is transmitted in parts. For example, the first type information is used as the first DCI for transmission, the second type information is used as the second DCI for transmission, and the third type information is used as the third DCI for transmission. Alternatively, for another example, the first-type information and the second-type information are used as first DCI for transmission, and the third-type information is used as second DCI for transmission. Alternatively, for another example, the first type information is used as the first DCI for transmission, and the second type information and the third type information are used as the second DCI for transmission. The information included in the DCI is transmitted in parts, so that the terminal device can process different types of information in parallel, thereby reducing a communication delay.

### Blind Detection of Terminal Devices

Because the terminal device does not know in advance which format DCI is carried on the received PDCCH, and does not know which candidate PDCCH is used to transmit the DCI, the terminal device must perform PDCCH blind detection to receive corresponding DCI. Before the terminal device successfully decodes the PDCCH, the terminal device may attempt to decode each possible candidate PDCCH until the terminal device successfully detects the PDCCH, or a quantity of DCI expected to be received by the terminal device or a quantity of blind detection times limit of the terminal device is reached.

In other words, the DCI has a plurality of different formats. When receiving the PDCCH, the terminal device cannot determine a DCI format to which the received DCI belongs, and therefore cannot correctly process data transmitted on a channel such as a PDSCH or a PUSCH. Therefore, the terminal device must perform blind detection on a format of the DCI. Generally, the terminal device does not know a format of the current DCI, and does not know a location of information required by the terminal device. However, the terminal device knows information in a format expected by the terminal device, and expected information in different formats corresponds to different expected RNTIs and CCEs. Therefore, the terminal device may perform CRC check on the received DCI by using the expected RNTI and the expected CCE, so as to know whether the received DCI is required by the terminal device, and also know a corresponding DCI format and a corresponding modulation scheme, so as to further access the DCI. The foregoing procedure is a blind detection process of the terminal device.

It should be understood that, a cyclic redundancy check (cyclic redundancy check, CRC) bit is usually added to the information bits of the DCI to implement an error detection function of the terminal device, and different types of radio network identifiers (radio network temporary identifier, RNTI) are used for scrambling in the CRC bits. Thus, the RNTI is implicitly encoded in the CRC bits. It should be further understood that different RNTIs can be used to both identify the terminal device and distinguish purposes of the DCI.

In addition, for a blind detection process of the terminal device, because the PDCCH includes a plurality of CCEs, or DCI is carried on the plurality of CCEs, the terminal device needs to perform blind detection on the plurality of CCEs. However, if the terminal device performs blind detection one by one at a granularity of CCEs, efficiency is relatively low. Therefore, a search space (search space) is specified in a protocol. The search space may be simply understood as that when the terminal device performs PDCCH blind detection, blind detection is performed by using several CCEs as a granularity. For example, if a value of an aggregation level AL of a CCE defined in the search space is 4 or 8, when the terminal device performs blind detection, Blind detection is performed at a granularity of four CCEs and then at a granularity of eight CCEs.

Specifically, when the value of the aggregation level AL of the CCE defined in the search space is 4 or 8, when the network device identifies the PDCCH, in addition to using the aggregation level parameter (a value of 4 or 8 is selected), A CCE location index (CCE index) parameter is further used, where the CCE location index is obtained through calculation based on time-frequency domain information of the PDCCH, an aggregation level, and the like. Because the terminal device cannot accurately know the aggregation level of the CCE occupied by the PDCCH and the start location index of the CCE, the terminal device receives higher layer signaling before receiving the PDCCH, where the higher layer signaling indicates time-frequency domain information of the PDCCH, and the like. In addition, the terminal device determines, based on a protocol, an indication of a network device, or the like, that the aggregation level of the PDCCH may be 4, or may be 8. Therefore, during blind detection, the terminal device may first use the aggregation level 4 and based on the time-frequency domain information of the PDCCH, calculating a position index (including a start position index of a CCE) of the CCE in the PDCCH, and performing blind detection on a corresponding CCE; and; Then, when the expected DCI is not detected or the quantity of DCI that is not expected to be detected reaches, the terminal device may further use the aggregation level 8 and based on the time-frequency domain information of the PDCCH, calculating a start position index (the position index of the CCE) of the CCE in the PDCCH, and performing blind detection on the corresponding CCE.

### Communication Service Availability (CSA)

CSA may be understood as that a receiver in a communication system receives available data, and receives the available data in a timely manner. The probability that the time from sending to receiving is within the maximum allowed end-to-end delay.

It should be understood that if the data received by the receiver is damaged, or the data is not received in time, (i.e., the time from sending to receiving exceeds the maximum allowed end-to-end delay), it is considered that a communications service corresponding to the data is unavailable.

The above describes possible scenarios or generalized description of the embodiments of the present disclosure, the motivation and technical concepts of the present disclosure are illustrated in the following.

Resilience is a fundamental feature that needs to be addressed in 6G. With the evolution of Industry 4.0 and many other technology visions, ultra-reliable and low latency wireless communications are pivotal enabler for automated manufacturing on a massive scale. Two trends are observed toward 6G. From the technological perspective, mmWave and massive MIMO (Multiple-Input Multiple-Output) will be more prevalent because they can significantly expand the current bandwidth resource. From the service perspective, a single device will need to support multiple services with different latency and reliability requirements. The two trends, together with the more stringent resilience requirement, provide an opportunity to re-design a physical layer.

A potential scenario emerges as multiple services converges into one physical wireless link. The purpose is to deliver multiple QoS (Quality of Service) to multiple services within only one wireless link. Given the high carrier frequency and massive antennas, beamforming can be done more aggressively, enabling the convergence of multiple services in one wireless link. Meanwhile, these services may have very diverse KPIs (Key Performance Indicator). As shown in FIG. 5, URLLC (Ultra-Reliable Low-Latency Communications), mMTC (massive Machine Type Communication), eMBB (enhanced Mobile Broadband) and Tbps communications may all be integrated in one beam. This is challenging because different KPIs must be supported under the same wireless channel, SNR (Signal to Interference plus Noise Ratio), fading, etc.

For two packets with different payload size and/or reliability/latency requirement, e.g. one eMBB packet with large payload size and another URLLC packet with small payload size and with higher reliability requirement, joint coding (or called mixed traffic coding) could be used for the two packets.

### Joint Coding (or Called Mixed Traffic Coding)

Joint coding refers to jointly encoding multiple packets (more than 1) into one codeword, e.g., jointly encoding a small packet (e.g., a URLLC packet) and a large packet (e.g., an eMBB packet) into one codeword. That is to say, there are multiple payloads in a joint codeword. For the joint encoding, there are two possible solutions:
Solution 1: encode multiple payloads into one codeword, where at least one payload is self-decodable (locally decodable) and global decodable;
Solution 2: encode multiple payloads into one codeword with unequal error protection.

For Solution 1, a self-decodable joint coding design is given, such that each individual payload (e.g., corresponding to a service) can be self-decoded, and at the same time joint decoding is supported to further enhance performance. Small messages (e.g., URLLC bits) are both locally and globally decodable, and a larger code block (e.g., containing eMBB bits) can be globally decodable. Specifically, local decoding is used as first attempt (lower reliable). If the local decoding succeeded, the small code can be used for enhancing the larger code since the correctly received small code provides prior information for the decoding of the larger code. If the local decoding failed, global decoding with the larger code is used as second attempt (higher reliable), that is, in the second attempt, the small code can be globally decoded (jointly decoded) with the larger code.

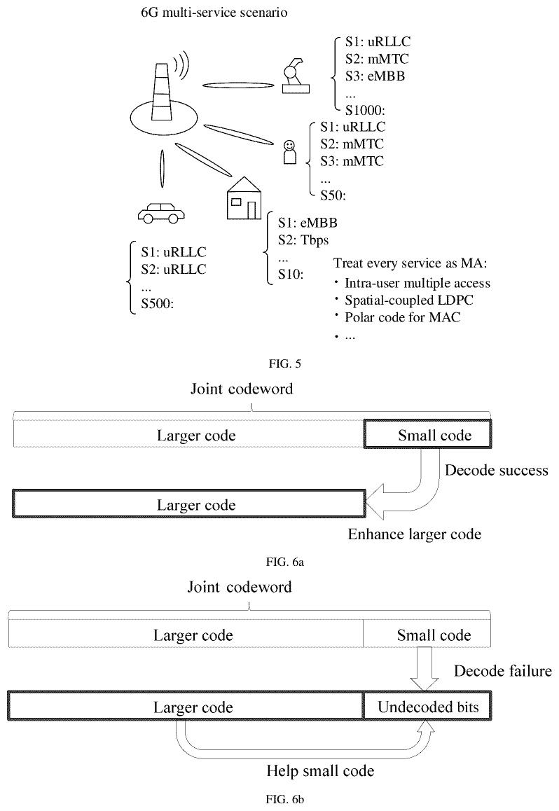

FIG. 6a and FIG. 6b are an illustration of self-decoding and joint-decoding (in the event of a self-decoding failure). As an example, several smaller or shorter messages may be embedded or otherwise combined into a longer code block or payload, also referred to herein as a combined payload. These smaller messages are self-decodable, meaning that they can be decoded after collecting only a subset of code bits, or symbols, or LLRs, associated with a longer codeword rather than the entire, longer codeword. The subset of code bits is also a standalone short code or codeword that is decodable on its own.

Two or more of such smaller messages are also jointly-decodable. The subsets of code bits corresponding to smaller messages that are jointly-decodable combine into a longer code. This may be accomplished through what is referred to herein as “coupling” between bits from multiple messages. For example, some or all of the bits of a first message (small code) may be copied and combined with bits of a second message (larger code). In this example, bits from the first message may be directly copied and appended to or otherwise combined with the bits of the second message. Another possible option is to first transform bits from the first message, by multiplying them with a binary matrix for example, and then appending the transformed bits to, or otherwise combining the transformed bits with, the bits of the second message.

Although this example refers to information bit (message) coupling, it is feasible to also or instead use coded bits for coupling. In the case of systematic codes, for example, message bits are also part of code bits, and thus the two alternatives, for information bit coupling or code bit coupling, become much the same.

Some embodiments support multiple decoding attempts before requesting retransmission. Joint decoding, for example, may in effect be inserted or attempted between a decoding failure and a retransmission request. As an example, consider an embodiment that involves a three decoding attempt transmission approach. Referring to FIG. 6a and FIG. 6b, in a first decoding attempt, a receiver receives a codeword and decodes a first self-decodable payload of the codeword after receiving a corresponding minimum of required code bits. If the decoding of the first payload is successful (FIG. 6a), then the correctly decoded bits can be used to enhance decoding performance for a second payload of the codeword, after a corresponding minimum required number of code bits for decoding of the second payload are received. A second decoding attempt is made if decoding of the first payload fails (FIG. 6b). Instead of immediately requesting a retransmission, the receiver instead proceeds to attempt to jointly decode the first payload with the second payload. After decoding of the second payload, regardless of whether there is success or failure of the second payload decoding, joint decoding can increase probability that the first payload will be successfully decoded. In this example, if decoding of the first payload still fails after the second (joint) decoding attempt, then the receiver requests a retransmission (not shown) from the transmitter. This will incur some delay, but with a retransmission the receiver can make at least a third decoding attempt. With a retransmitted codeword, multiple decoding attempts may further be made, to self-decode from the retransmitted codeword, jointly decode from parts of the retransmitted codeword, and/or jointly decode using both the previously received codeword and the retransmitted codeword.

By adopting the above solution, since some or all of the bits of the small code are copied and combined with bits of the larger code due to the joint coding, on one hand, after a successful decoding of a self-decodable code, the code rate of at least another code (e.g., eMBB bits) can be reduced, therefore resulting in an improved performance. That is, an augmented eMBB is achieved. On the other hand, if a self-decodable code (e.g., URLLC) fails to decode, instead of requesting a retransmission, the receiver proceeds to jointly decode the self-decodable code with the lager code. If the joint decoding is successfully, the code rate of the former can be reduced, resulting in an improved performance. That is, HARQ-less URLLC is achieved.

For Solution 2, a small URLLC packet is embedded to an eMBB packet. In short, the concept is one single FEC (Forward Error Correction) for multiple packets. In the encoder design, the priority order of the packets is taken into account, ensuring better protection for the packet with higher priority. Priority can be defined with different metrics, such as a reliability priority in terms of target BLER (Block Error Ratio), a latency priority in terms of latency requirement, a source priority where packets may come from different sources, e.g., in relay and multi-hop scenarios.

The solution may use separate CRC to allow individual packet decoding. When a packet fails to be decoded, the HARQ scheme would request a retransmission of the joint codeword.

Solution 2 can be regarded as “priority-based payload mapping”. FIG. 7 is a schematic illustration of joint coding of Solution 2. Specifically, as shown in FIG. 7, payload data (or packets) can be from different applications (or different sources). First, they are grouped by their QoS requirements and are CRC encoded separately. Then, a priority-based payload mapping procedure is performed to map each packet onto the information bit positions of a codeword according to reliability or latency. The reliability or latency of each bit depends on the specific channel coding scheme and decoding algorithms. FIG. 7 shows joint coding of two packets, i.e., a URLLC payload and an eMBB payload. In practice, there may be more than two packets jointly coded.

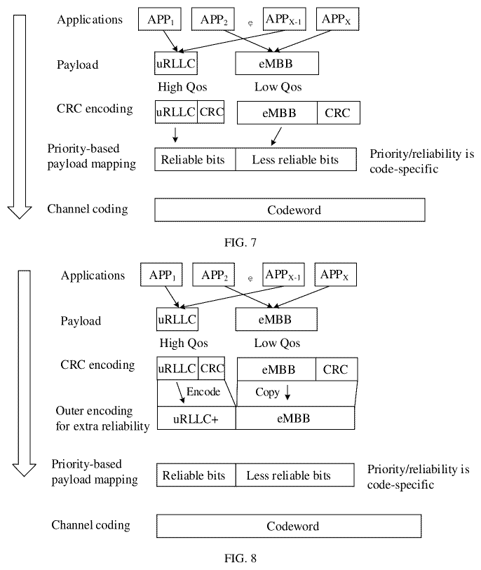

A possible enhancement of the above solution is to additionally protect the URLLC payload with an outer code. FIG. 8 is a schematic illustration of joint coding with the possible enhancement. This can achieve extra reliability for the URLLC payload. This is done by inserting another encoding process between CRC encoding and priority-based mapping, as shown in FIG. 8.

In the present disclosure, details on air interface designs for joint coding will be given, and the proposed air interface designs for join coding can be used in both of the above solutions. The mixed traffic corresponds to different UCI contents, or sensing-related data, or AI-related data, or any payload data that is transmitted on PUCCH or PUSCH. Two aspects are jointly considered to formulate the design. One is the priority of different traffic, and the other is the joint encoding for a plurality of traffic. These two features can be implemented during the bit sequence obtaining step in a PUCCH or a PUSCH.

In 5G NR, joint encoding of multiple UCI contents already exists. For example, HARQ-ACK and schedule request (SR) and CSI can be jointly encoded into one codeword. Starting from Release 16, the UCI content can be associated to two priority levels, one is high priority (HP) and the other is low priority (LP). Resource mapping and UE procedure are designed accordingly to deliver the priority differences. To summarize, the current priority-aware design supports the following mechanisms: UCI with different priorities are separately encoded; resource is guaranteed for HP code bits, but LP code bits can be dropped; in the same code block, HP bits are mapped first, LP bits second; code rate for HP bits is upper bounded.

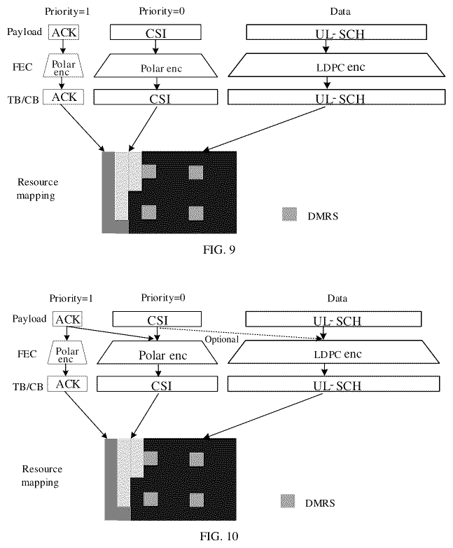

FIG. 9 is an illustration of the current resource mapping design, as shown, the current design does not support joint coding of payloads with different priorities.

However, different priorities mean that different levels of protection may be required. Therefore, to provide HP (high priority) bits with additional reliability, mixed-priority encoding can be introduced to UCI encoding, or more general data transmission scenarios, in this way, an unequal error protection may be enabled for payloads with different priorities.

The basic concepts of the present disclosure may be as follows. The current priority index may be reused to indicate a priority level, code blocks with different priority levels may be encoded separately or jointly, and a rate matching size may be sequentially allocated to realize different priorities. Specifically, code blocks with different priority indexes may be coupled to obtain mixed-priority UCI coding benefits. UCI with different priorities are no longer encoded separately. In an implementation manner, some highest-priority payload bits are mapped to multiple codewords, and thus are encoded multiple times. The mapping order of coupled bits should be polar coding aware, that is, high-priority payload bits are mapped to information bit positions with smaller indexes. FIG. 10 is an illustration of the proposed resource mapping design, as seen, the payload ACK is mapped to two polar codewords.

The above briefly describes technical concepts of the present disclosure, and then specific embodiments of the present disclosure will be elaborated in the following description.

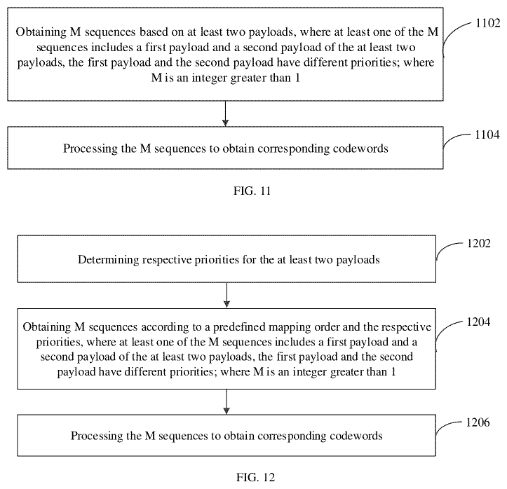

An embodiment of the present disclosure provides a data processing method which can be implemented by a terminal device. As shown in FIG. 11, the data processing method may include the following steps.

Step 1102, obtaining M sequences based on at least two payloads, where at least one of the M sequences includes a first payload and a second payload of the at least two payloads, the first payload and the second payload have different priorities; where M is an integer greater than 1.

From the perspective of service type, a payload may be from different applications or different sources, for example, the payload may be a uRLLC payload, an eMBB payload, etc. From the perspective of content carried in the payload, a payload may be UCI, CSI, UL-SCH data, etc. A sequence refers to a payload bit sequence, for example, a sequence based on a first payload and a second payload may be a sequence obtained by combining the payload bits of the first payload and the second payload. The sequence may be a sequence obtained by combining the payload bits of payloads with the same priority or with different priorities, among the M sequence, there is at least one sequence which includes payloads with different priorities. Here the first payload may be a payload among the at least two payloads, or the first payload may be part of a payload selected from the at least two payloads, which is not limited by the embodiments of the present disclosure. Similarly, the second payload may be a payload among the at least two payloads, or the second payload may be part of a payload selected from the at least two payloads, which is not limited by the embodiments of the present disclosure.

Currently, priority indexes are only assigned to UCI contents, e.g., ACK, CSI, etc. For example, PI=1 may be assigned to the payload ACK-HP, PI=0 may be assigned to the payload ACK-LP. It should be noted that, the example is only an illustration, different PI values can be determined for the UCI contents according to actual requirements. In 6G, a unified priority indexing framework may be designed to include all UL/DL traffic, e.g., UCI contents, UL-SCH data, UL sensing/AI traffics, DL-SCH data, DL sensing/AI traffics, etc.

The first payload and the second payload herein may refer to different UCI contents, UL-SCH data, etc. In a possible implementation manner, the first payload may be shared by at least two of the M sequence, that is, when there are at least two payloads, one of the payloads or a part of a payload selected from the payloads may be taken as the first payload which is ready for sharing between sequences. Here the sequences for sharing the first payload may be all the M sequences, or a part of the M sequences, which is not limited herein. For example, the first payload may be determined based on the payload with the highest priority, and may also be determined based on actual requirements. The specific determination for the first payload will be described later.

The M sequences may be obtained based on priorities. For example, the terminal device determines priorities of the payloads, and then obtains the sequences according to the mapping order preconfigured and the determined priorities. For another example, the M sequences may also be obtained without relying on priorities, which will be described later.

Step 1104, processing the M sequences to obtain corresponding codewords.

A codeword is used for carrying payload bits of certain traffic, e.g., UCI contents. After the M sequences are obtained, the M sequences may be encoded into corresponding codewords respectively. In a possible implementation, the M sequences may have M respective sequence indexes, a sequence index of a sequence and an index of a codeword are in one-to-one correspondence. The encoding scheme may include a polar encoding, an LDPC (Low Density Parity Check) encoding, etc. The M sequences may be encoded using the same encoding scheme or different encoding schemes. In addition, interleaving processing may be performed on some or all of the M sequences according to actual needs.

A sequence is obtained through combining payloads with different priorities, and then the sequence is processed to obtain a codeword, in this manner, joint encoding of payloads with different priorities is implemented, thus, payloads with different priority levels can be differentially transmitted, thereby providing unequal error protection from the perspective of channel coding.

In a possible implementation manner, the first payload may be shared by at least two of the M sequences, that is, payload bits corresponding to the first payload can be combined with payload bits corresponding to two or more payloads respectively. Thus, the first payload can be encoded multiple times into different codewords, the first payload can thus benefit from additional reliability.

In a possible implementation, the first payload is determined based on a relationship between the number of bits of a to-be-shared payload from which the first payload comes and a predefined sharing threshold; or, the first payload is determined based on a predefined number of codewords for carrying a to-be-shared payload and the number of bits of the to-be-shared payload. For example, the predefined sharing threshold is N payload bits, the number of bits of the to-be-shared payload is greater than N, where N is an integer, then the first N bits of the to-be-shared payload may be regarded as the first payload or bits of the first payload. For example, when the to-be-shared payload is the payload ACK-HP, the first N bits of the payload ACK-HP may be regarded as bits of the first payload. For another example, the number of bits of the to-be-shared payload is A, and the predefined number of codewords for carrying the to-be-shared payload is B, A bits of the to-be-shared payload may be shared among B codewords according to a predefined sharing principle, equally or unequally, e.g., in an equally distributing manner, the payload from the to-be-shared payload corresponding each codeword has A/B bits, and the A/B bits are regarded as the bits of the first payload, i.e., the first payload with A/B bits is shared among the B codewords and the first payload corresponding to each codeword can be coupled with other payloads to obtain a corresponding bit sequence.

Here the to-be-shared payload from which the first payload comes may have the highest priority among all the payloads (the at least two payloads), or may be determined based on actual needs. For example, the to-be-shared payload has the highest priority among the at least two payloads, in the case that there are multiple payloads with the same highest priority, some or all of the multiple payloads may be selected. In the case that there is only one payload with the highest priority, the first payload may be formed by all bits of the payload with the highest priority, or some of the bits of the payload with the highest priority. The latter may also be referred to as partial coupling, meaning only part of high-priority content (e.g., a few highest priority bits) can be shared by payload bits of different TBs (transport Blocks) or CBs (code blocks). In other words, high-priority bits are not all mapped to multiple codewords, but only part of the high-priority bits are encoded multiple times into different codewords. The shared part of the high-priority bits may be determined according to actual requirements, the current available resource, etc.

In addition, it should also be noted that, the to-be-shared payload having the highest priority is only an illustration, the first payload may also be determined according to actual requirements. That is, the first payload comes from which payload can be determined flexibly. Further, when the to-be-shared payload is determined based on actual needs, partial coupling may also happen in a similar way.

In a possible implementation, the data processing method further includes:
receiving a first notification from a network device, where the first notification is indicative of whether joint coding is enabled for M sequences;
step 1102 specifically includes:
upon determining that the first notification is indicative of joint coding being enabled for the M sequences, obtaining the M sequences based on the at least two payloads, where at least one of the M sequences includes a first payload and a second payload of the at least two payloads, the first payload and the second payload have different priorities; where M is an integer greater than 1.

The first notification may be sent to the terminal device from a network device through RRC (Radio Resource Control) signaling or DCI. A dedicated field can be added to RRC configuration or DCI formats to signal the terminal device. If the dedicated field is configured, it indicates joint coding being enabled for the bit sequences. Joint encoding of payloads with different priorities is implemented through the notification from the network device, by considering the compatibility with legacy coding schemes, the proposed joint encoding provides more flexibility and can thus meet different requirements.

The following implementations can be executed based on the above implementation, that is, the following implementations can be executed in the case that the first notification is transmitted from the network device to the terminal device. It should be noted that, the following implementations can also be executed in the case that the first notification is not transmitted from the network device to the terminal device, which is not limited here.

In a possible implementation, as shown in FIG. 12, the data processing method includes:
step 1202, determining respective priorities for the at least two payloads;
step 1204, obtaining M sequences according to a predefined mapping order and the respective priorities, where at least one of the M sequences includes a first payload and a second payload of the at least two payloads, the first payload and the second payload have different priorities; where M is an integer greater than 1;
step 1206, processing the M sequences to obtain corresponding codewords.

The sequence obtaining is based on priorities of payloads, and a mapping order may predefine a mapping rule for different priorities, for example, it may be predefined that bits of a payload with priority index PI=2 may be combined with bits of a payload with PI=1 and bits of a payload with PI=0 respectively. In the case that there are multiple payloads with the same priority, bits of the multiple payloads can be combined first as a whole. For example, there are two payloads with PI=1, and the mapping order predefines that bits of a payload with PI=1 are combined with bits of a payload with PI=0, in this case, bits of the two payloads with PI=1 can be combined first as a whole, and then the combined payload bits are further combined with bits of the payload with PI=0.

The respective priorities for the at least two payloads can be determined by the terminal device, and can also be notified by the network device. In a possible implementation, step 1202 includes: determining the respective priorities for the at least two payloads according to a predefined priority determination criterion; or, receiving a second notification from a network device, and determining the respective priorities for the at least two payloads according to the second notification, where the second notification is indicative of priorities of different payloads included in the at least two payloads. Specifically, the priority determination criterion is to determine a priority of a payload according to a relationship between a length of the payload and a predefined length threshold, or to determine a priority of a payload according to a type of the payload. For example, if a length of a payload is shorter than a certain threshold, the payload may have a low priority. For another example, if a length of a payload is shorter than a certain threshold, and to be encoded with a code rate lower than a predefined threshold, the payload may have a low priority. In addition, priority indexes may be assigned to different traffic through a unified priority indexing framework.

In a possible implementation, the terminal device is configured with a first correspondence between priorities and codeword sets; step 1204 may include:
determining at least one sequence index corresponding to each of the at least two payloads according to the first correspondence and the respective priorities for the at least two payloads;
obtaining M sequences according to the at least one sequence index corresponding to each of the at least two payloads, where at least one of the M sequences includes a first payload and a second payload of the at least two payloads, the first payload and the second payload have different priorities; where M is an integer greater than 1.

Here the sequence index also indicates an index of a sequence in which the payload appears, the codeword set (or also referred to as codeword index set) indicates the codeword(s) associated with each UCI content. The codeword set may include one or more codeword indexes, and a codeword index refers to a bit sequence index corresponding to a bit sequence to be obtained. If there are S separately encoded codewords, each codeword is denoted by an index chosen from {0, 1, 2, . . . , S−1}. Each UCI content is not only associated with a priority index, but also a codeword index set (CIS).

It should be noted that the first correspondence may also indicate the coding scheme corresponding to the codeword set, so after determining the codeword set corresponding to the payload, the coding scheme for this payload is also determined.

The UCI bit sequence obtaining can be achieved in an implicit way. First, each priority index is associated with a codeword index set. Then, each UCI content with an assigned priority index is automatically associated with a codeword index set through the priority index.

For each of the at least two payloads, since the first correspondence indicates the corresponding relationship between the priorities and the codeword sets, then the terminal device can first determine at least one sequence index according to the first correspondence and the respective priorities for the at least two payloads, that is, the terminal device can obtain the index(indices) of the codeword(s) for carrying the payload, since an index of a to-be-obtained sequence corresponds to an index of a codeword one by one (e.g., M sequences are indexed as 1, 2, . . . M and their corresponding codewords are also indexed as 1, 2, . . . M), the terminal device thus knows the index of the sequence (the aforementioned sequence index) in which the payload should appear, and obtains M sequences according to the at least one sequence index corresponding to each of the at least two payloads.

In a possible implementation, the terminal device is configured with a set of pre-configurations for obtaining the M sequences; the data processing method further includes:
receiving a third notification from a network device, where the third notification is indicative of a manner for obtaining M sequences;
selecting, according to the third notification, a mapping configuration from the set of pre-configurations as a predefined mapping order.

The terminal device may be configured with a set of pre-configurations for obtaining bit sequences, and a specific pre-configuration for obtaining the sequences can be indicated by RRC or DCI from the network device.

As described above, the bit sequence obtaining can be implemented according to a priority index (PI) and pre-configurations. In the existing structure, several pre-configurations of mixed-priority encoding can be specified, by associating each payload to a priority index. In this way, it only needs to specify the priority index of each content, and signal the pre-configuration to be used. Then all the encoding can be done accordingly.

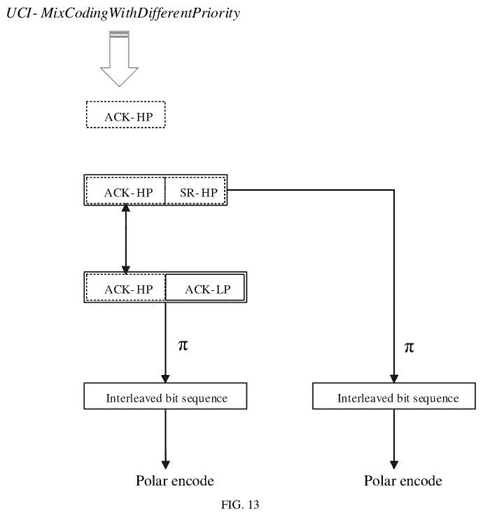

FIG. 13 illustrates an example regarding joint coding for UCI contents. To implement mixed-priority coding of different UCI contents with minimum specification impact, UCI payload bit sequences are obtained by combining payload bits of different priorities; and the payload bits are interleaved before polar encoding. In FIG. 13, ACK-HP is one example of the aforementioned first payload, and ACK-LP is one example of the aforementioned second payload. ACK-HP is coupled with ACK-LP to obtain a bit sequence. Of course, if there is an SR-HP, it is also an exemplary first payload.

A field called UCI-MixCodingWithDifferentPriority can be added to RRC configuration or DCI formats to signal a UE. The aforementioned first notification may be in a form of RRC signaling or DCI including the UCI-MixCodingWithDifferentPriority field. Within UCI only, a specific mapping order can be explicitly specified. A hardcode example is illustrated. If UCI-MixCodingWithDifferentPriority is configured, and if any of HARQ-ACK bits associated with priority index 0, HARQ-ACK bits associated with priority index 1, and SR associated with priority index 1 are transmitted on a PUCCH, two UCI bit sequences are obtained, i.e.,

$${a}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )} and {a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )} ,$$

according to the following, where A⁽¹⁾=O^{ACK-HP}+O^{SR-HP} and A⁽²⁾=O^{ACK-HP}+O^{ACK-LP}
The HARQ-ACK bits associated with priority index 1 are mapped to the UCI bit sequence

$${a}_{0}^{( 1 )} , {a}_{1}^{( 1 )} , {a}_{2}^{( 1 )} , {a}_{3}^{( 1 )} , … , {a}_{{O}^{ACK - HP} - 1}^{( 1 )} ,$$

where

$${a}_{i}^{( 1 )} = {\tilde{o}}_{i}^{ACK - HP}$$

for i=0, 1, . . . , O^{ACK-HP}−1, the HARQ-ACK bit sequence

$${\tilde{o}}_{0}^{ACK - HP} , {\tilde{o}}_{1}^{ACK - HP} , … , {\tilde{o}}_{{O}_{i}^{ACK - HP} - 1}^{ACK - HP}$$

is given by Clause 9.1 of [5, TS 38.213], and O^{ACK-HP} is the number of HARQ-ACK bits associated with priority index 1.
If there is SR associated with priority index 1 for transmission on the PUCCH, set

$${a}_{i}^{( 1 )} = {\tilde{o}}_{i - {O}^{ACK - HP}}^{SR - HP} for i = {O}^{ACK - HP} , {O}^{ACK - HP} + 1 , … , {O}^{ACK - HP} + {O}^{SR - HP} - 1 ,$$

where the SR bit sequence

$${\tilde{o}}_{0}^{SR - HP} , {\tilde{o}}_{1}^{SR - HP} , … , {\tilde{o}}_{{O}^{SR - HP} - 1}^{SR - HP}$$

is given by Clause 9.2.5.1 of [5, TS 38.213]; if there is no SR associated with priority index 1 for transmission on the PUCCH, set O^{SR-HP}=0.
Both the HARQ-ACK bits associated with priority index 1 and the HARQ-ACK bits associated with priority index 0 are mapped to the UCI bit sequence

$${a}_{0}^{( 2 )} , {a}_{1}^{( 2 )} , {a}_{2}^{( 2 )} , {a}_{3}^{( 2 )} , … , {a}_{{O}^{ACK - HP} + {O}^{ACK - LP} - 1}^{( 2 )} , where {a}_{i}^{( 2 )} = {a}_{i}^{( 1 )} = {\tilde{o}}_{i}^{ACK - HP} for i = 0 , 1 , … , {O}^{ACK - HP} - 1 , and {a}_{i}^{( 2 )} = {\tilde{o}}_{i - {O}^{ACK - HP}}^{ACK - LP} for i = {O}^{ACK - HP} , {O}^{ACK - HP} + 1 , … , {O}^{ACK - HP} +$$

O^{ACK-LP}−1, the HARQ-ACK bit sequence

$${\tilde{o}}_{0}^{ACK - LP} , {\tilde{o}}_{1}^{ACK - LP} , … , {\tilde{o}}_{{O}^{ACK - LP} - 1}^{ACK - LP}$$

is given by Clause 9.1 of [5, TS 38.213], and O^{ACK-LP} is the number of HARQ-ACK bits associated with priority index 0.

In a possible implementation, interleaving processing can be applied to payload bits before polar coding. The UCI bit sequences

$${a}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )} and$$

$${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$$

are interleaved according to ascending reliability order, where a_{π(i)}, is always mapped to a less reliable subchannel than a_{π(j)} if i<j. The reliability is defined in Table 5.3.1.2-1 of [5, TS 38.212]. The reliability-interleaved bit sequences are

$${a}_{π ( 0 )}^{( 1 )} , {a}_{π ( 1 )}^{( 1 )} , {a}_{π ( 2 )}^{( 1 )} , {a}_{π ( 3 )}^{( 1 )} , … , {a}_{π ( {A}^{( 1 )} - 1 )}^{( 1 )} and$$

$${a}_{π ( 0 )}^{( 2 )} , {a}_{π ( 1 )}^{( 2 )} , {a}_{π ( 2 )}^{( 2 )} , {a}_{π ( 3 )}^{( 2 )} , … , {a}_{π ( {A}^{( 1 )} - 1 )}^{( 2 )} .$$

Channel coding is performed based on the reliability-interleaved bit sequences using existing methods, for example, the way defined in Clause 6.3.1.3.1 of [5, TS 38.212], using the rate matching output sequence length Er given in Clause 6.3.2.4.1 of [5, TS 38.212].

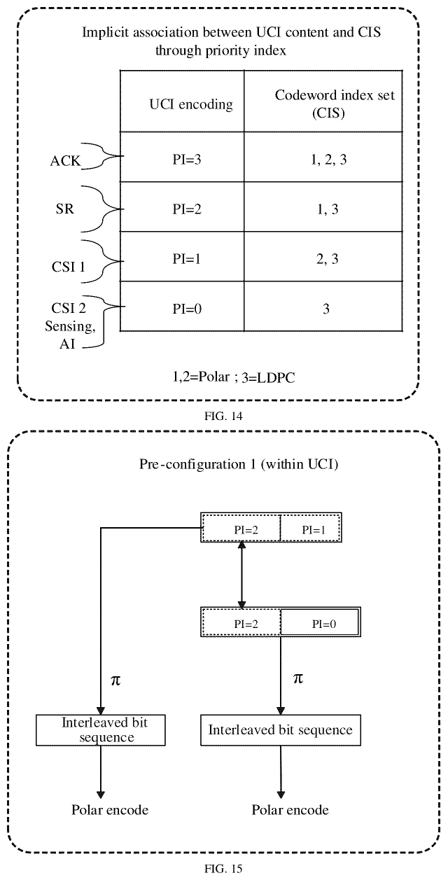

FIG. 14 is a schematic illustration of a first correspondence between priorities and codeword sets. As shown in FIG. 14, in the case that the first correspondence between priorities and codeword sets indicates that PI=3 corresponds to a codeword index set of {1, 2, 3}, and PI=2 corresponds to a codeword index set of {1, 3}, it is determined that PI of the payload ACK is 3, PI of the payload SR is 2, in this case, according to the above data processing method, it is thus determined that the sequence indices of the payload ACK are 1, 2, 3, and the sequence indices of the payload SR are 1, 3, since the indices in the CIS also indicate the indexes of the sequences in which the UCI content appears, that is to say, the payload ACK should appear in the first, second and third sequences, and the payload SR should appear in the first and the third sequences, so the first and the third sequences both have the ACK and the payload SR, i.e., the payload ACK and the payload SR may be coupled to obtain two bit sequences with polar encoding and LDPC encoding respectively, i.e., a sequence index (also referred to as bit sequence index) 1 and a sequence index 3.

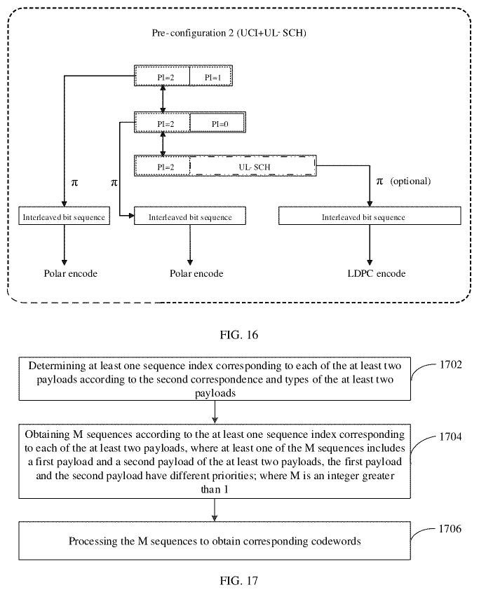

FIG. 15 is an example of a pre-configuration for joint encoding, as shown in FIG. 15, for UCI with PI=2, 1, 0 (the larger, the higher priority), UCI with PI=2 and UCI with PI=1 are jointly encoded using polar codes, and UCI with PI=2 and UCI with PI=0 are jointly encoded using polar codes. FIG. 16 is another example of a pre-configuration for joint encoding, as shown in FIG. 16, for UCI with PI=2, 1, 0 (the larger, the higher priority) and UL-SCH, UCI with PI=2 and UCI with PI=1 are jointly encoded using polar codes, UCI with PI=2 and UCI with PI=0 are jointly encoded using polar codes, and UCI with PI=2 and UL-SCH are jointly encoded using LDPC codes.

In addition to the UCI contents, sensing (e.g., multipath feedback) and/or AI contents can join the mixed-priority coding, as long as a priority index is assigned to each content. Sensing and/or AI contents can be regarded as control information (UCI), or data (UL-SCH). Specifically, whether sensing and/or AI contents are mapped to UCI or UL-SCH may depend on their sizes, and typically a smaller sized payload goes to UCI and a larger sized payload goes to UL-SCH. A threshold may be predefined to make the decision.

Joint encoding of payloads with different priorities is implemented through pre-configurations, thus a more flexible manner to configure the mixed-priority encoding is provided, and data channel in the framework can easily be included in the mixed-priority encoding. In other words, a generally applicable design of mixed-priority encoding is provided, and a joint encoding scheme can be configured more flexibly according to actual requirements.

In a possible implementation, the terminal device is configured with a second correspondence between a payload and a codeword set for carrying the payload; as shown in FIG. 17, the data processing method includes:
step 1702, determining at least one sequence index corresponding to each of the at least two payloads according to the second correspondence and types of the at least two payloads;
step 1704, obtaining M sequences according to the at least one sequence index corresponding to each of the at least two payloads, where at least one of the M sequences includes a first payload and a second payload of the at least two payloads, the first payload and the second payload have different priorities; where M is an integer greater than 1;
step 1706, processing the M sequences to obtain corresponding codewords.

This implementation is similar to the implementation configured with the first correspondence between priorities and codeword sets, the sequence index also indicates an index of a sequence in which the payload appears, the difference lies in that the determination of the priority of the payload is skipped in this implementation. The UCI bit sequence obtaining can be achieved in an explicit way, i.e., through a direct association between UCI contents and codeword index sets. The assignment of a codeword index set to a UCI content can be statically predefined, or dynamically signaled through RRC or DCI. Similarly, the second correspondence may also indicate the coding scheme corresponding to the codeword set, so after determining the codeword set corresponding to the payload, the coding scheme for this payload is also determined.

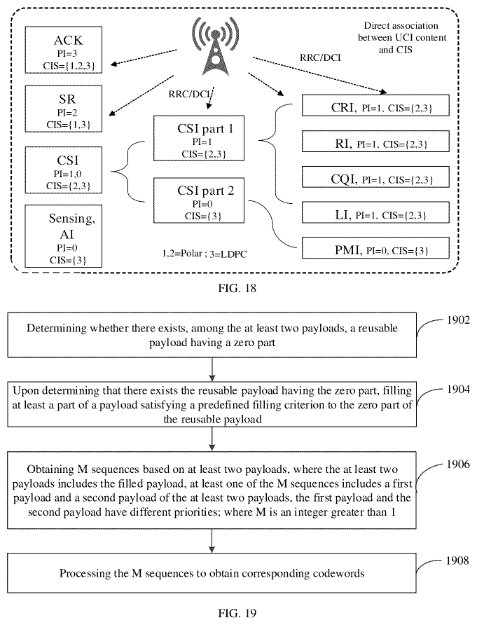

FIG. 18 is a schematic illustration of a second correspondence between a payload and a codeword set for carrying the payload. As shown in FIG. 18, the payload ACK corresponds to a codeword index set of {1, 2, 3}, the payload SR corresponds to a codeword index set of {1, 3}, etc. A codeword index 1 or 2 corresponds to polar encoding, and a codeword index 3 corresponds to LDPC encoding. It is thus determined that the sequence indices of the payload ACK are 1, 2, 3, and the sequence indices of the payload SR are 1, 3, since the indices in the CIS also indicate the indexes of the sequences for carrying the UCI content, that is to say, the payload ACK should appear in the first, second and third sequences, and the payload SR should appear in the first and the third sequences, so the first and the third sequences both have the ACK and the payload SR, i.e., the payload ACK and the payload SR may be coupled to obtain two bit sequences with polar encoding and LDPC encoding respectively, i.e., a sequence index 1 and a sequence index 3.

Such a CIS index can directly specify the encoding manners of mixed-priority coding, without having to explicitly define the priority indexes of multiple payloads, the overhead is small. A more fine-grained priority levels may also be supported.

It should be noted that the codeword index set in this implementation and the foregoing implementation may be called other names, e.g., a CB (code block) index set, a TB (transport block) index set, but it generally means which codeword(s) will carry the payload bits (or part of it) of certain traffic.

In NR (New Radio), there are several zero-padding bits in certain UCI contents (e.g., in CSI reports). In 6G, lots of zero-padding occasions are expected in order to have better alignment of resource. These bits can be utilized to re-transmit high-priority bits.

In a possible implementation, as shown in FIG. 19, the data processing method includes:
step 1902, determining whether there exists, among the at least two payloads, a reusable payload having a zero part;
step 1904, upon determining that there exists the reusable payload having the zero part, filling at least a part of a payload satisfying a predefined filling criterion to the zero part of the reusable payload;
step 1906, obtaining M sequences based on at least two payloads, where the at least two payloads includes the filled payload, at least one of the M sequences includes a first payload and a second payload of the at least two payloads, the first payload and the second payload have different priorities; where M is an integer greater than 1;
step 1908, processing the M sequences to obtain corresponding codewords.

A payload satisfying a predefined filling criterion may be a payload with the highest priority, or a predefined payload (e.g., the payload ACK). Specifically, the payload satisfying a predefined filling criterion may be the first payload shared by at least two sequences, and may also be other payloads. Further, the payload satisfying a predefined filling criterion may be the reusable payload having a zero part, for example, bits are selected from the non-zero part of the reusable payload for filling. In the case that a length of the zero part is longer than a length of payload bits for filling, the payload bits may be repeated for multiple times.

Since the zero part is filled with bits of a certain payload, the zero part can be utilized to transmit the filled payload bits, the utilization rate of the payload is thus improved, meanwhile, the bits filled in the zero part of the reusable payload can also benefit from joint encoding.

FIG. 20 is a schematic illustration of filling a zero part of a payload, part of payload bits for ACK in the first UCI codeword is also copied to the zero-padding bit positions in the CSI in the second UCI codeword. To have a better separate and joint encoding performance, these copied bits can be interleaved to the beginning of the payload bits of the second UCI codeword.

It should be noted that, the highest reliable bits in the first payload are copied to zero-padding bit positions in the second payload, where the number of the copied bits is equal to, or less than the number of zero-padding bits. In a possible implementation, the copied high-priority bits are interleaved to the front of the corresponding bit sequence, such that they are assigned to least reliable sub-channels before polar encoding.

The above solution requires less modification to the existing structure. In addition, since the high reliable bits in the first payload are encoded once more, reliability for the first codeword is improved, and the highest reliable bits in the first payload are copied to zero-padding bit positions in the second payload, thus, no performance loss for the second codeword.

In a possible implementation, the processing the M sequences to obtain corresponding codewords may include: performing interleaving processing on a first sequence of the M sequences; encoding the first interleaved sequence and a rest of the M sequences according to a coding scheme corresponding to each of the M sequences to obtain the corresponding codewords; and the data processing method further includes: performing rate matching on the corresponding codewords.

The interleaving processing may be independent for each sequence, that is, interleaving processing may be performed on some or all of the M sequences according to actual needs. The coding scheme may include a polar encoding, an LDPC (Low Density Parity Check) encoding, etc. Regarding the rate matching, a length of an output sequence of the rate matching for a codeword is determined based on a manner in which a sequence corresponding to the codeword is obtained.

The rate matching part requires modification to better support native priority-awareness. For UCI with different priority indexes on PUCCH, the following table may be obtained.

| UCI encoding | Value of E_{UCI} |
|---|---|
| PI = 2 | ${E}_{UCI}^{P 2} = min ( {E}_{t o t} , ⌈ ( {O}^{P 2} + L ) / {R}_{UCI}^{max - P 2} / {Q}_{m} ⌉ \cdot {Q}_{m} )$ |
| PI = 1 | ${E}_{UCI}^{P 1} = min ( {E}_{t o t} - {E}_{UCI}^{P 2} , ⌈ ( {O}^{P 2} + {O}^{P 1} + L ) / {R}_{UCI}^{max - P 1} / {Q}_{m} ⌉ \cdot {Q}_{m} )$ |
| PI = 0 | ${E}_{UCI}^{P 0} = min ( {E}_{t o t} - {E}_{UCI}^{P 2} - {E}_{UCI}^{P 1} , ⌈ ( {O}^{P 2} + {O}^{P 1} + {O}^{P 0} + L ) / {R}_{UCI}^{max - P 0} / {Q}_{m} ⌉ \cdot {Q}_{m} )$ |

A general expression for a length of an out sequence of rate matching, assuming the highest priority index=h, would be:

$${E}_{UCI}^{Pl} = min ( {E}_{tot} - {\sum }_{i = l + 1}^{h} {E}_{UCI}^{Pi} , ⌈ ( {\sum }_{i = l + 1}^{h} {O}^{Pi} + {O}^{Pl} + L ) / {R}_{UCI}^{max - Pl} / {Q}_{m} ⌉ \cdot {Q}_{m} )$$

where

$${E}_{UCI}^{P 1} ,$$

is the length of an out sequence of rate matching for UCI content with priority index l,
O^{Pi} is the number of payload bits for UCI content with priority index l,

$${R}_{UCI}^{max - Pl}$$

is the configured maximum PUCCH coding rate of priority index l.

It should be noted that in the case of partial coupling,

$${\sum }_{i = l + 1}^{h} {O}^{Pi}$$

can be replaced with

$${\sum }_{i = l + 1}^{h} {O}^{′ Pi} ,$$

where O′^{Pi} is the number of partial payload bits to be shared.

For UCI with different priority indexes on PUSCH, the following formulas may be obtained:

$${Q}_{P 2}^{′} = min \{ ⌈ \frac{( {O}_{P 2} + {L}_{P 2} ) \cdot {β}_{offset}^{PUSCH} \cdot {\sum }_{l = 0}^{{N}_{symb , all}^{PUSCH} - 1} {M}_{sc}^{UCI} ( l )}{\frac{1}{{N}_{s}} {\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

$${Q}_{P 1}^{′} = min \{ ⌈ \frac{( {O}_{P 2} + {O}_{P 1} + {L}_{P 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{P 2}^{′} \}$$

$${Q}_{P 0}^{′} = min \{ ⌈ \frac{( {O}_{P 2} + {O}_{P 1} + {O}_{P 0} + {L}_{P 0} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{P 2}^{′} - {Q}_{P 1}^{′} \}$$

where

$${Q}_{Pl}^{′}$$

is the number of coded modulation symbols per layer for transmission of UCI with priority index 1.

Similar to the case of PUCCH, O_{P2}, O_{P1} can be replaced with the number of partial payload bits to be shared O′_{P2}, O′_{P1}.

Taking PUCCH as an example, the number of payload bits for UCI content with priority index 2 is considered for determining the length of the output sequence of the rate matching for the payload with PI=1 and PI=0, and the number of payload bits for UCI content with priority index 1 is considered for determining the length of the output sequence of the rate matching for the payload with PI=0, so the payload with higher priority will affect the rate matching calculation of the payload with lower priority.

To summarize, the main modifications in both PUCCH and PUSCH are the inclusion of high-priority payload bits in low-priority payload during the calculation of rate matched code length or rate matched number of symbols.

The above solution brings minimum impact to the existing structure. In addition, the unequal error protection for payloads of different priorities is provided.

The foregoing method embodiments describe the resolution from the perspective of the terminal device. It should be understood by a person skilled in the art that, the resolution can also be described from the perspective of a network device. For example, after processing the M sequences to obtain corresponding codewords, the terminal device sends the corresponding codewords to the network device. Correspondingly, an embodiment of the present disclosure may provide a data processing method which can be implemented by the network device. The data processing method may include: the network device receives codewords from the terminal device, where the codewords are obtained by the terminal device through processing M sequences, the M sequences are obtained based on at least two payloads, where at least one of the M sequences includes a first payload and a second payload of the at least two payloads, the first payload and the second payload have different priorities; where M is an integer greater than 1.

In a possible implementation, the first payload is shared by at least two of the M sequences.

In a possible implementation, the network device sends a first notification to the terminal device, where the first notification is indicative of whether joint coding is enabled for the M sequences, so that the terminal device obtains the M sequences based on the at least two payloads upon determining that the first notification is indicative of joint coding being enabled for the M sequences.

In a possible implementation, the network device sends a second notification to the terminal device, where the second notification is indicative of priorities of different payloads included in the at least two payloads, so that the terminal device determines respective priorities for the at least two payloads according to the second notification and obtains the M sequences according to a predefined mapping order and the respective priorities.

In a possible implementation, the network device sends a third notification to the terminal device, where the third notification is indicative of a manner for obtaining the M sequences, so that the terminal device selects, according to the third notification, a mapping configuration from a set of pre-configurations configured for the terminal device as a predefined mapping order and obtains the M sequences according to a predefined mapping order and respective priorities.

It should be understood by a person skilled in the art that, the relevant description of the data processing method from the perspective of the network device in the embodiments of the present disclosure may be understood with reference to the relevant description of the data processing method from the perspective of the terminal device in the embodiments of the present disclosure.

Next, embodiments of products related to the data processing methods will be described.

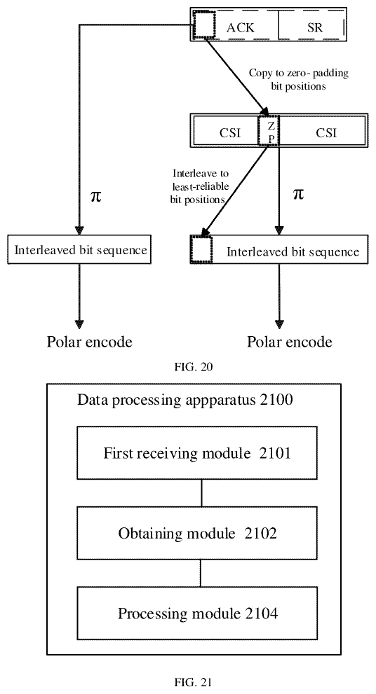

FIG. 21 illustrates a block diagram of a data processing apparatus 2100 according to an embodiment of the present disclosure. As shown in FIG. 21, the apparatus 2100 includes:
an obtaining module 2102, configured to obtain M sequences based on at least two payloads, where at least one of the M sequences includes a first payload and a second payload of the at least two payloads, the first payload and the second payload have different priorities; where M is an integer greater than 1;
a processing module 2104, configured to process the M sequences to obtain corresponding codewords.

In a possible implementation, the first payload is shared by at least two of the M sequences.

In a possible implementation, the apparatus 2100 further includes: a first receiving module 2101, configured to receive a first notification from a network device, where the first notification is indicative of whether joint coding is enabled for the M sequences; where the obtaining module 2102 is specifically configured to: upon determining that the first notification is indicative of joint coding being enabled for the M sequences, obtain the M sequences based on the at least two payloads.

In a possible implementation, the obtaining module 2102 includes: a determining sub-module, configured to determine respective priorities for the at least two payloads; an obtaining sub-module, configured to obtain the M sequences according to a predefined mapping order and the respective priorities.

In a possible implementation, the determining sub-module is specifically configured to: determine the respective priorities for the at least two payloads according to a predefined priority determination criterion; or, receive a second notification from a network device, and determine the respective priorities for the at least two payloads according to the second notification, where the second notification is indicative of priorities of different payloads included in the at least two payloads.

In a possible implementation, the priority determination criterion is to determine a priority of a payload according to a relationship between a length of the payload and a predefined length threshold, or to determine a priority of a payload according to a type of the payload.

In a possible implementation, the apparatus 2100 is configured with a first correspondence between priorities and codeword sets; the obtaining sub-module is specifically configured to: determine at least one sequence index corresponding to each of the at least two payloads according to the first correspondence and the respective priorities for the at least two payloads; obtain the M sequences according to the at least one sequence index corresponding to each of the at least two payloads.

In a possible implementation, the apparatus 2100 is configured with a set of pre-configurations for obtaining the M sequences; the apparatus 2100 further includes: a second receiving module, configured to receive a third notification from a network device, where the third notification is indicative of a manner for obtaining the M sequences; a selecting module, configured to select, according to the third notification, a mapping configuration from the set of pre-configurations as the predefined mapping order.

In a possible implementation, the apparatus 2100 is configured with a second correspondence between a payload and a codeword set for carrying the payload; the obtaining module 2102 is specifically configured to: determine at least one sequence index corresponding to each of the at least two payloads according to the second correspondence and types of the at least two payloads; obtain the M sequences according to the at least one sequence index corresponding to each of the at least two payloads.

In a possible implementation, the apparatus 2100 further includes: a determining module, configured to determine whether there exists, among the at least two payloads, a reusable payload having a zero part; a filling module, configured to upon determining that there exists the reusable payload having the zero part, fill at least a part of a payload satisfying a predefined filling criterion to the zero part of the reusable payload, and use the filled reusable payload for the obtaining of the M sequences.

In a possible implementation, the processing module 2104 is specifically configured to: perform interleaving processing on a first sequence of the M sequences; encode the first interleaved sequence and a rest of the M sequences according to a coding scheme corresponding to each of the M sequences to obtain the corresponding codewords; the apparatus 2100 further includes: a rate matching module, configured to perform rate matching on the corresponding codewords.

In a possible implementation, a length of an output sequence of the rate matching for a codeword is determined based on a manner in which a sequence corresponding to the codeword is obtained.

In a possible implementation, the first payload is determined based on a relationship between the number of bits of a to-be-shared payload from which the first payload comes and a predefined sharing threshold; or, the first payload is determined based on a predefined number of codewords for carrying the to-be-shared payload and the number of bits of the to-be-shared payload.

In a possible implementation, the first payload has a highest priority among the at least two payloads.

In a possible implementation, the apparatus further includes a sending module, configured to send the codewords corresponding to the M sequences to a network device.

The data processing apparatus may be applied to the terminal device as described in the above method embodiments or may be the terminal device as described in the above method embodiments. It should be understood by a person skilled in the art that, the relevant description of the above modules in the embodiments of the present disclosure may be understood with reference to the relevant description of the data processing method in the embodiments of the present disclosure.

An embodiment of the present disclosure provides a data processing apparatus including a receiving module, configured to receive codewords from a terminal device, where the codewords are obtained by the terminal device through processing M sequences, the M sequences are obtained based on at least two payloads, where at least one of the M sequences includes a first payload and a second payload of the at least two payloads, the first payload and the second payload have different priorities; where M is an integer greater than 1.

In a possible implementation, the apparatus further includes a first sending module, configured to send a first notification to the terminal device, where the first notification is indicative of whether joint coding is enabled for the M sequences, so that the terminal device obtains the M sequences based on the at least two payloads upon determining that the first notification is indicative of joint coding being enabled for the M sequences.

In a possible implementation, the apparatus further includes a second sending module, configured to send a second notification to the terminal device, where the second notification is indicative of priorities of different payloads included in the at least two payloads, so that the terminal device determines respective priorities for the at least two payloads according to the second notification and obtains the M sequences according to a predefined mapping order and the respective priorities.

In a possible implementation, the apparatus further includes a third sending module, configured to send a third notification to the terminal device, where the third notification is indicative of a manner for obtaining the M sequences, so that the terminal device selects, according to the third notification, a mapping configuration from a set of pre-configurations configured for the terminal device as a predefined mapping order and obtains the M sequences according to a predefined mapping order and respective priorities.

The data processing apparatus may be applied to the network device as described in the above method embodiments or may be the network device as described in the above method embodiments. It should be understood by a person skilled in the art that, the relevant description of the modules in the embodiments of the present disclosure may be understood with reference to the relevant description of the data processing method in the embodiments of the present disclosure.

An embodiment of the present disclosure provides a terminal device including processing circuitry for executing any of the above data processing method. It should be understood that the terminal device can execute the steps performed by the terminal device in the method embodiments, which will not be repeated here.

An embodiment of the present disclosure provides a network device including processing circuitry for executing any of the data processing method. It should be understood that the network device can execute the steps performed by the network device in the method embodiments, which will not be repeated here.

An embodiment of the present disclosure provides a wireless communication system, including a network device and a terminal device. The terminal device is configured to execute the steps executed by the terminal device in any of the data processing method, and the network device is configured to execute the steps executed by the network device in any of the data processing method.

An embodiment of the present disclosure provides a chip, including an input/output (I/O) interface and a processor, where the processor is configured to call and run computer execution instructions stored in a memory, to enable a device installing with the chip to execute any of the above data processing methods.

An embodiment of the present disclosure provides a computer-readable medium storing computer execution instructions which, when executed by a processor, causes the processor to execute any of the above data processing methods.

An embodiment of the present disclosure provides a computer program product including computer execution instructions which, when executed by a processor, causes the processor to execute any of the above data processing methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

What is claimed is:

1. A method, comprising:
obtaining, by a terminal device, M sequences based on at least two payloads, wherein at least one of the M sequences comprises a first payload and a second payload of the at least two payloads, the first payload and the second payload have different priorities, and wherein M is an integer greater than 1; and
processing, by the terminal device, the M sequences to obtain corresponding codewords.

2. The method according to claim 1, wherein the first payload is shared by at least two of the M sequences.

3. The method according to claim 1, further comprising:
receiving, by the terminal device, a first notification from a network device, wherein the first notification is indicative of whether joint coding is enabled for the M sequences; and
wherein obtaining, by the terminal device, the M sequences based on the at least two payloads comprises:
upon determining that the first notification is indicative of joint coding being enabled for the M sequences, obtaining, by the terminal device, the M sequences based on the at least two payloads.

4. The method according to claim 1, wherein obtaining, by the terminal device, the M sequences based on the at least two payloads comprises:
determining, by the terminal device, respective priorities for the at least two payloads; and
obtaining, by the terminal device, the M sequences according to a predefined mapping order and the respective priorities.

5. The method according to claim 4, wherein determining, by the terminal device, the respective priorities for the at least two payloads comprises:
determining, by the terminal device, the respective priorities for the at least two payloads according to a predefined priority determination criterion; or,
receiving, by the terminal device, a second notification from a network device, and determining the respective priorities for the at least two payloads according to the second notification, wherein the second notification is indicative of priorities of different payloads comprised in the at least two payloads.

6. The method according to claim 5, wherein the predefined priority determination criterion is to determine a priority of a payload according to a relationship between a length of the payload and a predefined length threshold, or to determine a priority of a payload according to a type of the payload.

7. The method according to claim 4, wherein the terminal device is configured with a first correspondence between priorities and codeword sets; and
wherein obtaining, by the terminal device, the M sequences according to the predefined mapping order and the respective priorities comprises:
determining, by the terminal device, at least one sequence index corresponding to each of the at least two payloads according to the first correspondence and the respective priorities for the at least two payloads; and
obtaining, by the terminal device, the M sequences according to the at least one sequence index corresponding to each of the at least two payloads.

8. An apparatus, comprising:
at least one processor coupled with a memory storing instructions, wherein when the at least one processor executes the instructions, the apparatus is caused to:
obtain M sequences based on at least two payloads, wherein at least one of the M sequences comprises a first payload and a second payload of the at least two payloads, the first payload and the second payload have different priorities, and wherein M is an integer greater than 1; and
process the M sequences to obtain corresponding codewords.

9. The apparatus according to claim 8, wherein the first payload is shared by at least two of the M sequences.

10. The apparatus according to claim 8, wherein when the at least one processor executes the instructions, the apparatus is further caused to:
receive a first notification from a network device, wherein the first notification is indicative of whether joint coding is enabled for the M sequences; and
wherein obtaining the M sequences based on at least two payloads comprises:
upon determining that the first notification is indicative of joint coding being enabled for the M sequences, obtaining the M sequences based on the at least two payloads.

11. The apparatus according to claim 8, wherein obtaining the M sequences based on the at least two payloads comprises:
determining respective priorities for the at least two payloads; and
obtaining the M sequences according to a predefined mapping order and the respective priorities.

12. The apparatus according to claim 11, wherein determining the respective priorities for the at least two payloads comprises:
determining the respective priorities for the at least two payloads according to a predefined priority determination criterion; or,
receiving a second notification from a network device, and determining the respective priorities for the at least two payloads according to the second notification, wherein the second notification is indicative of priorities of different payloads comprised in the at least two payloads.

13. The apparatus according to claim 12, wherein the predefined priority determination criterion is to determine a priority of a payload according to a relationship between a length of the payload and a predefined length threshold, or to determine a priority of a payload according to a type of the payload.

14. The apparatus according to claim 11, wherein the apparatus is configured with a first correspondence between priorities and codeword sets; and
wherein obtaining the M sequences according to a predefined mapping order and the respective priorities comprises:
determining at least one sequence index corresponding to each of the at least two payloads according to the first correspondence and the respective priorities for the at least two payloads; and
obtaining the M sequences according to the at least one sequence index corresponding to each of the at least two payloads.

15. A non-transitory computer-readable medium storing computer execution instructions which, when executed by at least one processor, causes the at least one processor to:
obtain M sequences based on at least two payloads, wherein at least one of the M sequences comprises a first payload and a second payload of the at least two payloads, the first payload and the second payload have different priorities, and wherein M is an integer greater than 1; and
process the M sequences to obtain corresponding codewords.

16. The non-transitory computer-readable medium according to claim 15, wherein the first payload is shared by at least two of the M sequences.

17. The non-transitory computer-readable medium according to claim 15, when the instructions are executed by the at least one processor, the at least one processor is further caused to:
receive a first notification from a network device, wherein the first notification is indicative of whether joint coding is enabled for the M sequences; and
wherein obtaining the M sequences based on the at least two payloads comprises:
upon determining that the first notification is indicative of joint coding being enabled for the M sequences, obtaining the M sequences based on the at least two payloads.

18. The non-transitory computer-readable medium according to claim 15, wherein obtaining the M sequences based on the at least two payloads comprises:
determining respective priorities for the at least two payloads; and
obtaining the M sequences according to a predefined mapping order and the respective priorities.

19. The non-transitory computer-readable medium according to claim 18, wherein determining respective priorities for the at least two payloads comprises:
determining the respective priorities for the at least two payloads according to a predefined priority determination criterion; or,
receiving a second notification from a network device, and determine the respective priorities for the at least two payloads according to the second notification, wherein the second notification is indicative of priorities of different payloads comprised in the at least two payloads.

20. The non-transitory computer-readable medium according to claim 19, wherein the predefined priority determination criterion is to determine a priority of a payload according to a relationship between a length of the payload and a predefined length threshold, or to determine a priority of a payload according to a type of the payload.
